(19) United States
(12) Patent Application Publication
(10) Pub. No.: US 2026/0204650 A1
(43) Pub. Date: Jul. 16, 2026

(54) SEMI-SOLID STATE BATTERY AND PREPARATION METHOD THEREFOR

(71) Applicant: TIANNENG BATTERY GROUP CO., LTD., HUZHOU CITY, Zhejiang Province (CN)

(72) Inventors: HAIYUAN ZHANG, HUZHOU, ZHEJIANG PROVINCE (CN); YU LI, HUZHOU, ZHEJIANG PROVINCE (CN); HAIMIN ZHAO, HUZHOU, ZHEJIANG PROVINCE (CN); HAO ZHANG, HUZHOU, ZHEJIANG PROVINCE (CN); GUANG HE, HUZHOU, ZHEJIANG PROVINCE (CN); YIFEI LU, HUZHOU, ZHEJIANG PROVINCE (CN); HONGJIE WANG, HUZHOU, ZHEJIANG PROVINCE (CN); KUNGUANG HONG, HUZHOU, ZHEJIANG PROVINCE (CN); SHUQIANG WANG, HUZHOU, ZHEJIANG PROVINCE (CN)

(21) Appl. No.: 19/135,914

(22) PCT Filed: Dec. 20, 2022
(86) PCT No.: PCT/CN2022/140310

§ 371 Date: Jun. 5, 2025

(30) Foreign Application Priority Data
Dec. 5, 2022 (CN) 202211546195.0

(51) Int. Cl. H01M 10/0585; H01M 10/0565

(52) U.S. Cl. CPC H01M 10/0585; H01M 10/0565; H01M 2300/0082

(57) ABSTRACT

The present invention is a semi-solid state battery and a preparation method therefor. In the method for preparing the semi-solid state battery of the present invention, due to different polymerization rates of two different reactive monomers, polymers with different chain lengths and molecular weights are generated. Self-assembly stratification of an electrolyte occurs gradually with polymerization reaction time and in-situ curing time, and the self-assembly stratification of an entire cell system also occurs gradually over time. Interfaces between upper and lower polymer layers achieve mutual penetration and uniform transition to form an interface-free state beneficial for tighter and stronger bonding between the two layers. The comprehensive electrolyte structure can improve safety and cycle stability of the in-situ polymerization battery. By adopting the self-assembled in-situ polymerization method, interfacial impedance between the electrolyte and electrodes inside the battery is reduced. The method is simple and easy to scale up for mass production.

### TECHNICAL FIELD

The present invention belongs to the technical field of secondary batteries, and particularly relates to a semi-solid state battery and a preparation method therefor.

### BACKGROUND TECHNOLOGY

At present, commercially available lithium secondary batteries on a large scale contain a large amount of flammable and leak-prone organic carbonate small-molecule solvents, which pose significant safety hazards. Replacing traditional electrolytes with non-volatile and non-combustible solid-state electrolytes is considered as an effective means to solve safety problems of lithium-ion batteries. Polymer electrolytes have become a research hotspot in recent years due to their low interfacial impedance and high safety. However, due to complex processes and stability issues of polymer's own electrical properties, they have not rapidly entered mass production.

To improve the preparation process of polymer lithium batteries and enhance production efficiency, researchers have proposed an in-situ curing technology. This technology involves injecting liquid monomers into an interior of a battery cell by a liquid injection method, and then initiating polymerization of the monomers under certain conditions after infiltration to form an in-situ solid state battery. For example, a Chinese patent application with a publication number CN105914405A proposes a method of injecting liquid epoxides and lithium salts into the interior of battery, and triggering in-situ ring-opening curing under heating conditions to form an integrated all-solid state polymer battery. A Chinese patent application with a publication number CN108493486A discloses dissolving acrylic esters and initiators in electrolyte, injecting the mixture into the interior of the battery, and triggering polymerization of unsaturated double bonds under heating to form an integrated gel polymer battery. A Chinese patent application with a publication number CN111533851A disclosing mixing small-molecule carbonic acid alkenes containing double bonds, ethylene glycol acrylates, and initiators, injecting the mixture into an interface of a solid state battery, and triggering thermal polymerization to form an electrode-electrolyte integrated all-solid-state battery. A Chinese patent application with a publication number CN111540956A discloses dissolving isocyanates and polypropylene glycols in electrolyte, injecting the solution into a battery, and electro-polymerizing it into an integrated battery to reduce electrode-electrolyte interfacial impedance.

The above prior art all uses polymer materials to prepare an integrated single-layer structure. However, the lithium-ion batteries have a wide voltage range, and a polymer material usually cannot balance high-voltage and low-voltage stability simultaneously. To solve this problem, researchers have developed a composite electrolyte membrane with a multi-layer structure. Two sides close to positive and negative electrodes are respectively composed of polymer components with oxidation resistance and reduction resistance, significantly improving an electrochemical stability window of the electrolytes. For example, a Chinese patent application with a publication number CN109565078A provides a multi-layer structure electrolyte, wherein polyester and polyether electrolyte films are respectively prepared by a solvent evaporation method, and a composite film is formed by combining esters with strong oxidation resistance and ethers with strong ion conductivity and lower interfacial impedance, and an assembled solid state battery shows significantly improved cycle stability. A Chinese patent application with a publication number CN110048158A utilizes a casting method to in-situ polymerize a double-layer structure electrolyte membrane on both sides of a porous membrane, with one side being esters and the other side being ethers, wherein this membrane meets the stability requirements of a high-voltage positive electrode and a low-voltage negative electrode simultaneously. A Chinese patent application with a publication number CN110581314A discloses coating inorganic solid state electrolytes on a side of a support separator in contact with a positive electrode and polymer electrolytes on a side of the support separator in contact with a negative electrode, reducing electrolyte oxidation and improving battery safety and cycle stability of the battery.

However, the multi-layer composite membranes reported currently have complex processes. Most of them involve coating a membrane outside a cell and then compounding it with an electrode sheet, resulting in poor contact between electrolytes and an electrode, large impedance, and unfavorable for battery capacity performance. A Chinese patent application with a publication number CN114335716A disclosing mixing reactive monomers into positive and negative electrodes and adding reaction aids such as crosslinking agents into electrolyte to perform in-situ polymerization. However, if it is necessary to simultaneously meet the reaction of the crosslinking agents with both the positive and negative electrodes simultaneously, a material selection is extremely strict, and the selectable systems are very limited, which greatly restricts an original intention of enabling both positive electrode oxidation resistance and negative electrode reduction resistance to play their roles. If two types of initiators or reaction systems are selected, the two systems compete and affect each other, leading to incomplete reactions. Moreover, polymerization reaction needs to be carried out rapidly after injecting the electrolyte; otherwise, the monomers of the positive and negative electrodes penetrate each other with infiltration of the electrolyte, ultimately weakening the stratification effect of the positive and negative electrodes. Therefore, the methods in the prior art involving composite electrolyte membranes with multi-layer structures are more suitable for laboratory preparation rather than industrialized mass production.

### SUMMARY OF INVENTION

In view of the above-mentioned deficiencies in the prior art, the present application provides a semi-solid state battery and a preparation method therefor, which is an interface-free semi-solid state battery with an in-situ self-assembled multi-layer network electrolyte structure.

The present invention adopts an in-situ polymerization method for self-assembly inside the battery, forming a multi-layer electrolyte network structure in one step without an interface among layers and between electrolyte and positive and negative electrodes. The electrolyte exhibits both high-voltage oxidation resistance at the positive electrode and reduction resistance at the negative electrode. The preparation method of the present invention enhances interfacial contact between the electrodes and the electrolyte, thereby improving the safety and cycle stability of a battery cell. Meanwhile, it is compatible with existing lithium-ion battery manufacturing processes and equipment, simplifying preparation process of in-situ polymerization batteries with multi-layer electrolyte structures for rapid mass production.

The core of the present invention lies in designing molecular structures of monomers for the in-situ polymerization at the positive and negative electrodes, such that the two monomers have different polymerization rates to form polymer long chains with different molecular weights. A polymer long chain with a higher molecular weight gradually settles down to a lower layer and adheres to a negative electrode surface, while a polymer long chain with a lower molecular weight floats on an upper layer and adheres to a positive electrode surface. With deepening of an in-situ curing degree, the electrolyte forms a self-assembled two-layer structure of upper and lower layers that respectively adsorb onto surfaces of the positive and negative electrodes, achieving the design objective. Interfaces between upper and lower polymer layers achieve mutual penetration and uniform transition, which is beneficial for tighter and stronger bonding between the two layers.

A method for preparing a semi-solid state battery, the semi-solid state battery comprising a cell and an electrolyte, the cell comprising stacked positive and negative electrodes, wherein the preparation method comprises the following steps:
(1) mixing a first reactive monomer, a second reactive monomer, and a portion of a basal electrolyte solution to obtain an in-situ polymerization electrolyte precursor I;
(2) mixing an initiator with a remainder of the basal electrolyte solution to obtain an in-situ polymerization electrolyte precursor II, the initiator being used to initiate polymerization of the first reactive monomer and polymerization of the second reactive monomer respectively; and
(3) first injecting the in-situ polymerization electrolyte precursor I into the cell to wet the positive and negative electrodes, then injecting the in-situ polymerization electrolyte precursor II into the cell, heating the cell to a polymerization temperature to initiate in-situ polymerization, and forming a semi-solid state battery having a multi-layer network electrolyte structure,
wherein the first reactive monomer has a faster polymerization rate and forms a polymer with a higher molecular weight than the second reactive monomer.

The object of the present invention is to enable two reactive monomers to polymerize sequentially through different polymerization reaction times. The reactive monomer that polymerizes first settles downward, while the other reactive monomer floats upward during the polymerization of the other monomer and eventually polymerizes. Thus, the object of the present invention of forming a multi-layer structure via in-situ differential polymerization can be achieved merely by ensuring a certain time difference in the polymerization reaction time of the two monomers. Preferably, the first reactive monomer completes at least 80% of the polymerization within 60 seconds of reaction after addition of the initiator; and the second reactive monomer completes less than 50% of the polymerization within 60 seconds of reaction after the addition of the initiator.

Preferably, the first reactive monomer is at least one of the followings: methyl methacrylate, 1,3-dioxolane, methyl acrylate, and polyethylene glycol dimethacrylate; and the second reactive monomer is at least one of the followings: polyethylene glycol methacrylate, dimethyl allylmalonate, and vinylene carbonate.

The initiator is at least one of the followings: azobisisobutyronitrile and benzoyl peroxide.

A mass fraction of the second reactive monomer in the in-situ polymerization electrolyte precursor I is 5% to 45%; and
a mass fraction of the second reactive monomer in the in-situ polymerization electrolyte precursor I is 0.5% to 45%; and
a mass fraction of the initiator in the in-situ polymerization electrolyte precursor II is 0.1% to 5%.

Preferably, in the step (3), the in-situ polymerization electrolyte precursor I and the in-situ polymerization electrolyte precursor II are added in a mass ratio of 1:1. Obviously, the addition ratio of the in-situ polymerization electrolyte precursor I and the in-situ polymerization electrolyte precursor II may also be adaptively adjusted by modifying a concentration of each solution, and it does not necessarily require addition in the mass ratio of 1:1. For example, by increasing the concentration of the initiator when preparing the in-situ polymerization electrolyte precursor II, the addition amount of the in-situ polymerization electrolyte precursor II may be correspondingly reduced while maintaining the same total initiator content when both precursors are added. The same principle applies to the addition of the first and second reactive monomers: if the concentration in the in-situ polymerization electrolyte precursor I is higher, the addition amount of the in-situ polymerization electrolyte precursor I may be reduced; and if the concentration in the in-situ polymerization electrolyte precursor I is lower, the addition amount of the in-situ polymerization electrolyte precursor I may be increased.

The heating temperature during the in-situ polymerization may be set according to different requirements, and the required temperatures are also different when different reactive monomers polymerize with different initiators. Preferably, in the step (3), during the in-situ polymerization, the heating temperature is 45° C. to 90° C. and the heating time is 5 minutes to 48 hours. Further and preferably, in the step (3), after the heating during the in-situ polymerization, standing is performed at a standing temperature of 25° C. to 45° C. for a standing time of 24 hours to 120 hours.

The present invention also provides a semi-solid state battery prepared by the preparation method. Preferably, the semi-solid state battery is a semi-solid state button battery or a semi-solid state stacked pouch battery. Since the polymerization reaction in the present application relies on natural sedimentation stratification, it is more suitable for stacked structure batteries, which are placed horizontally to facilitate the natural sedimentation stratification during the polymerization reaction.

The two reactive monomers have different polymerization rates to form polymer long chains with different molecular weights. With the standing time, a polymer long chain with a higher molecular weight gradually settles down to a lower layer and adheres to a negative electrode surface, while a polymer short chain with a lower molecular weight floats on an upper layer and adheres to a positive electrode surface. With deepening of an in-situ curing degree, the electrolyte forms a self-assembled two-layer structure of upper and lower layers that respectively adsorb onto surfaces of the positive and negative electrodes, achieving an objective of protecting both the positive and negative electrodes. By the same principle, the present invention allows for inverting positions of the positive and negative electrodes in the cell, resulting in a configuration where the high-molecular-weight polymer is adjacent to the positive electrode and the low-molecular-weight polymer is adjacent to the negative electrode.

In the method for preparing the semi-solid state battery of the present invention, a main mechanism of the self-assembled stratification is that the different reactive monomers designed in the present invention have different polymerization rates, so that polymers with different chain lengths and molecular weights are generated; self-assembly stratification of an electrolyte occurs gradually with polymerization reaction time and in-situ curing time; and the self-assembly stratification of an entire cell system also occurs gradually over time. Interfaces between upper and lower polymer layers achieve mutual penetration and uniform transition to form an interface-free state which is beneficial for tighter and stronger bonding between the two layers. The different electrolyte layers designed in the present invention perform different functions: the electrolyte layer on the negative electrode side mainly contains reduction-resistant groups, which serve to coat the negative electrode, suppress lithium dendrite growth, and enhance cycle performance; and the electrolyte layer on the positive electrode side mainly contains oxidation-resistant groups, which serve to coat the positive electrode, prevent metal dissolution and structural collapse, and improve safety and stability. The comprehensive electrolyte structure can improve safety and cycle stability of the in-situ polymerization battery. By adopting the self-assembled in-situ polymerization method, interfacial impedance between the electrolyte and electrodes inside the battery is reduced. The method is simple and easy to scale up for mass production.

### BRIEF DESCRIPTION OF THE DRAWINGS

FIG. 1 is a schematic diagram of an internal partial structure of a semi-solid state battery of the present invention.

FIG. 2 is a flow chart of a preparation method of the semi-solid state battery of the present invention.

FIG. 3 is a schematic diagram of a stacked structure of a stacked pouch battery prepared according to Example 8.

FIG. 4 is a schematic diagram of a stacked structure of a new stacked pouch battery prepared according to Example 14.

FIG. 5 is a discharge capacity curve.

FIG. 6 is a graph of cycle life test results.

### DETAILED DESCRIPTION OF THE PREFERRED EMBODIMENTS

In examples and comparative examples of this application, components of basal electrolyte solution used are the same. The components of the basal electrolyte solution are, by a volume ratio, EC:EMC:DEC=1:1:1, and LiPF₆ is 1 mol/L.

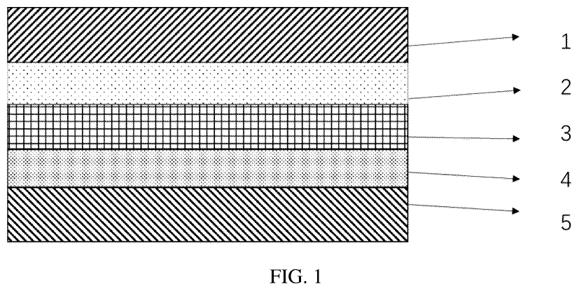

FIG. 1 is a schematic diagram of an internal partial structure of a semi-solid state battery of the present invention. In FIG. 1, reference number 1: positive electrode layer, reference number 2: electrolyte layer adhered to positive electrode, reference number 3: separator, reference number 4: electrolyte layer adhered to negative electrode, and reference number 5: negative electrode.

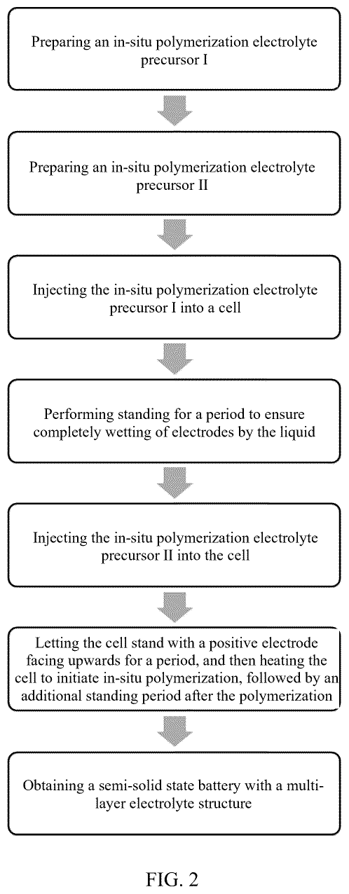

FIG. 2 is a flow chart of a preparation method of the semi-solid state battery of the present invention, comprising the following steps:
(1) preparing an in-situ polymerization electrolyte precursor I,
(2) preparing an in-situ polymerization electrolyte precursor II, and
(3) injecting the in-situ polymerization electrolyte precursor I into the cell to wet the positive and negative electrodes, performing standing until the liquid completely wets the electrodes; injecting the in-situ polymerization electrolyte precursor II into the cell, standing the cell with the positive electrode facing upward for a period of time; and then heating the cell to initiate the in-situ polymerization, and performing standing for a period of time after the polymerization, so as to form a semi-solid state battery having a multi-layer electrolyte structure.

All liquid injection processes are carried out in a glove box or a dry room with an air dew point controlled below −45° C.

### Example 1

(1) 5 g of methyl methacrylate (MMA) and 0.01 g of initiator azobisisobutyronitrile (AIBN) were respectively added into a glass bottle and stirred for 2 hours until the solution was uniformly mixed. The glass bottle was placed in an oven at 60° C. for different polymerization time to observe a degree of polymerization. It was observed that liquid content in the bottle was less than 20% after 1 minute of polymerization, indicating that the degree of monomer polymerization was above 80%.

TABLE 1

| Type of reactive | | |
|---|---|---|
| monomer 1 | Type of initiator | Polymerization rate |
| MMA | AIBN | Degree of monomer |
| DOL | BPO | polymerization is above |
| MA | BPO | 80% within 1 minute |
| PEGDMA | BPO | |

As shown in Table 1, the methyl methacrylate (MMA), 1,3-dioxolane (DOL), methyl acrylate (MA), and polyethylene glycol dimethacrylate (PEGDMA) were screened by the same method, all of which achieve the degree of polymerization being above 80% within 1 minute.

(2) 5 g of methyl methacrylate (PEGMA) and 0.01 g of initiator azobisisobutyronitrile (AIBN) were respectively added into a glass bottle and stirred for 2 hours until the solution was uniformly mixed. The glass bottle was placed in an oven at 60° C. for different polymerization time to observe a degree of polymerization. It was observed that liquid content in the bottle was more than 50% after 1 minute of polymerization, indicating that the degree of the monomer polymerization was below 50%.

TABLE 2

| Type of reactive monomer 2 | Type of initiator | Polymerization rate |
|---|---|---|
| PEGMA | AIBN | Degree of monomer |
| Dimethyl allylmalonate | AIBN | polymerization is less |
| VC | AIBN | than 50% within 1 |
| PEGMA | BPO | minute |
| VC | BPO | |

As shown in Table 1, the polyethylene glycol methyl acrylate (PEGMA), dimethyl allylmalonate, and vinylene carbonate (VC) were screened by the same method, all of which achieve the degree of polymerization being below 50% within 1 minute.

### Example 2

Method for preparing semi-solid button battery:

(1) Sequentially adding 0.5 g of methyl methacrylate (MMA) as a reactive monomer 1 and 0.5 g of polyethylene glycol methyl acrylate (PEGMA) as a reactive monomer 2 to 9 g of basal electrolyte solution, and stirring for 24 hours until solution was uniformly mixed to obtain an in-situ polymerization electrolyte precursor I.

(2) Adding 0.01 g of initiator azobisisobutyronitrile (AIBN) to 9.99 g of the basal electrolyte solution and stirring for 24 hours until the initiator was completely dissolved to obtain an in-situ polymerization electrolyte precursor II.

(3) Preparing a button battery with a lithium iron phosphate electrode sheet as a positive electrode and a lithium metal sheet as a negative electrode, dropping the in-situ polymerization electrolyte precursor I prepared in the step (1) into the battery and performing standing for 1 hour to ensure completely wetting of the electrodes; then dropping the in-situ polymerization electrolyte precursor II prepared in the step (2) into the battery, standing a cell with the positive electrode facing upward for 12 hours, then heating the cell in an oven at 60° C. for 1 hour to initiate in-situ polymerization; and after the polymerization, performing standing at 25° C. for additional 72 hours to allow polymer sedimentation and stratification, thereby preparing a semi-solid button battery with a two-layer electrolyte structure.

### Example 3

Method for preparing semi-solid button battery:

(1) Sequentially adding 4.5 g of MMA as a reactive monomer 1 and 0.5 g of dimethyl allylmalonate as a reactive monomer 2 to 5 g of basal electrolyte solution, and stirring for 24 hours until solution was uniformly mixed to obtain an in-situ polymerization electrolyte precursor I.

(2) Being the same as the step (2) in Example 2.

(3) The rest being the same as the step (3) in Example 2, except that the heating time in the oven at 60° C. was 12 hours.

### Example 4

Method for preparing semi-solid button battery:

(1) Sequentially adding 4.5 g of MMA as a reactive monomer 1 and 4.5 g of vinylene carbonate (VC) as a reactive monomer 2 to 1 g of basal electrolyte solution, and stirring for 24 hours until solution was uniformly mixed to obtain an in-situ polymerization electrolyte precursor I.

(2) Being the same as the step (2) in Example 2.

(3) The rest being the same as the step (3) in Example 2, except that the heating time in the oven at 60° C. was 48 hours and the standing time after the polymerization was 24 hours.

### Example 5

Method for preparing semi-solid button battery:

(1) Being the same as the step (1) in Example 2, except that the reactive monomer 1 was changed to DOL.

(2) Being the same as the step (2) in Example 2, except that the initiator was changed to benzoyl peroxide (BPO).

(3) The rest being the same as the step (3) in Example 2, except that the cell was placed in the oven at 45° C. for 12 hours to initiate the in-situ polymerization.

### Example 6

Method for preparing semi-solid button battery:

(1) Being the same as the step (1) in Example 2, except that the reactive monomer 1 was changed to MA and the reactive monomer 2 was changed to VC.

(2) Adding 0.5 g of initiator BPO to 9.5 g of the basal electrolyte solution and stirring for 24 hours until the initiator was completely dissolved to obtain an in-situ polymerization electrolyte precursor II.

(3) The rest being the same as the step (3) in Example 2, except that the cell was placed in the oven at 90° C. for 12 hours to initiate the in-situ polymerization, and then was placed on standing at 45° C. for additional 120 hours to allow polymer sedimentation and stratification, thereby preparing a semi-solid button battery with a two-layer electrolyte structure.

### Example 7

Method for preparing semi-solid button battery:

(1) Sequentially adding 0.5 g of PEGDMA as a reactive monomer 1 and 0.05 g of polyethylene glycol methyl acrylate (PEGMA) as a reactive monomer 2 to 9.45 g of basal electrolyte solution, and stirring for 24 hours until solution was uniformly mixed to obtain an in-situ polymerization electrolyte precursor I.

(2) Being the same as the step (2) in Example 2, except that the initiator was changed to BPO.

(3) The rest being the same as the step (3) in Example 2, except that the cell was placed in the oven at 60° C. for 5 minutes to initiate the in-situ polymerization.

### Example 8

Method for preparing semi-solid state stacked pouch battery:

(1) Being the same as the step (1) in Example 2.

(2) Being the same as the step (2) in Example 2.

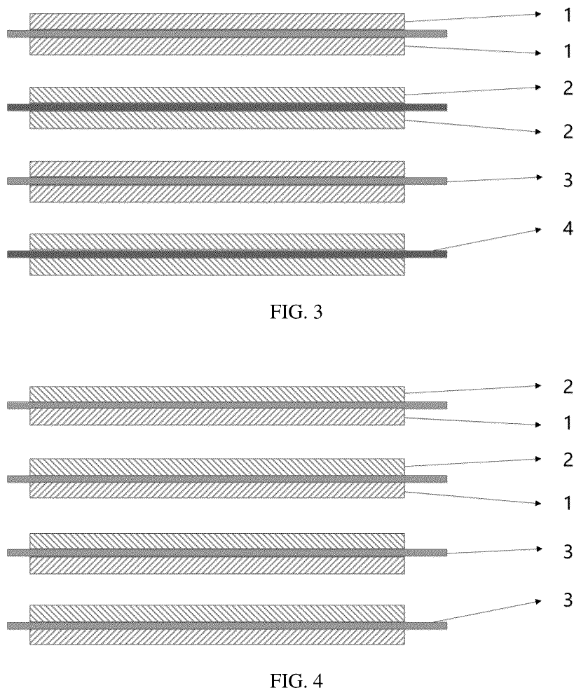

(3) Assembling a ternary cathode sheet, a graphite anode sheet, a PE porous separator, and an aluminum-plastic film into an unfilled dry cell by layer-by-layer lamination, which was dried at 90° C. for 24 hours and reserved for use. A stacking structure of the battery was shown in FIG. 3, wherein a reference number 1 refers to a cathode layer, a reference number 2 refers to an anode layer, a reference number 3 refers to a cathode current collector, and reference number 4 refers to an anode current collector.

(3) Injecting the in-situ polymerization electrolyte precursor I prepared in the step (1) into the dry cell; after standing for 24 hours to allow the liquid to completely wet the electrodes, injecting the in-situ polymerization electrolyte precursor II prepared in the step (2) into the cell; standing the cell with the positive electrode facing upward for 12 hours, then heating the cell in an oven at 60° C. for 1 hour to initiate in-situ polymerization; and after the polymerization, performing standing at 25° C. for additional 72 hours to allow polymer sedimentation and stratification, and forming a low-molecular-weight short-chain polymer layer adhering to a positive electrode side and a high-molecular-weight long-chain polymer layer adhering to a negative electrode side, thereby preparing a semi-solid state stacked pouch battery with a two-layer electrolyte structure.

### Example 9

Method for preparing semi-solid state stacked pouch battery:

(1) Being the same as the step (1) in Example 3.

(2) Being the same as the step (2) in Example 3.

(3) The rest being the same as the step (3) in Example 8, except that the cell was placed in the oven at 60° C. for 12 hours to initiate the in-situ polymerization and was placed on standing at 45° C. for additional 72 hours to allow polymer sedimentation and stratification.

### Example 10

Method for preparing semi-solid state stacked pouch battery:

(1) Being the same as the step (1) in Example 4.

(2) Being the same as the step (2) in Example 4.

(3) Being the same as the step (3) in Example 8, except that the cell was placed in the oven at 60° C. for 48 hours to initiate the in-situ polymerization, and then was placed on standing at 45° C. for additional 24 hours to allow polymer sedimentation and stratification.

### Example 11

Method for preparing semi-solid state stacked pouch battery:

(1) Being the same as the step (1) in Example 5.

(2) Being the same as the step (2) in Example 5.

(3) The rest being the same as the step (3) in Example 8, except that the cell was placed in the oven at 45° C. for 12 hours to initiate the in-situ polymerization and was placed on standing at 25° C. for additional 72 hours to allow polymer sedimentation and stratification.

### Example 12

Method for preparing semi-solid state stacked pouch battery:

(1) Being the same as the step (1) in Example 6.

(2) Being the same as the step (2) in Example 6.

(3) Being the same as the step (3) in Example 8, except that the cell was placed in the oven at 90° C. for 12 hours to initiate the in-situ polymerization, and then was placed on standing at 25° C. for additional 120 hours to allow polymer sedimentation and stratification.

### Example 13

Method for preparing semi-solid state stacked pouch battery:

(1) Being the same as the step (1) in Example 7.

(2) Being the same as the step (2) in Example 7.

(3) Being the same as the step (3) in Example 8, except that the cell was placed and heated in the oven at 60° C. for 5 minutes to initiate the in-situ polymerization, and then was placed on standing at 25° C. for additional 120 hours to allow polymer sedimentation and stratification.

### Example 14

Method for preparing semi-solid state stacked pouch battery:

(1) Being the same as the step (1) in Example 2.

(2) Being the same as the step (2) in Example 2.

(3) Assembling a ternary cathode sheet, a graphite anode sheet, a PE porous separator, and an aluminum-plastic film into an unfilled dry cell by a novel lamination method, which was dried at 90° C. for 24 hours and reserved for use. A stacking structure of the battery was shown in FIG. 4, wherein a reference number 1 refers to a cathode layer, a reference number 2 refers to an anode layer, and a reference number 3 refers to a current collector.

(3) Injecting the in-situ polymerization electrolyte precursor I prepared in the step (1) into the dry cell; after standing for 24 hours to allow the liquid to completely wet the electrodes, injecting the in-situ polymerization electrolyte precursor II prepared in the step (2) into the cell; standing the cell with the positive electrode facing upward for 12 hours, then heating the cell in an oven at 60° C. for 6 hours to initiate in-situ polymerization; and after the polymerization, performing standing at 25° C. for additional 24 hours to allow polymer sedimentation and stratification, and forming a low-molecular-weight short-chain polymer layer adhering to a positive electrode side and a high-molecular-weight long-chain polymer layer adhering to a negative electrode side, thereby preparing a semi-solid state stacked pouch battery with a two-layer electrolyte structure.

### Comparative Example 1

(1) Preparing basal electrolyte solution.

(2) Using a lithium iron phosphate electrode sheet as a positive electrode and a lithium metal sheet as a negative electrode to prepare a button battery; and dropping the basal electrolyte solution prepared in the step (1) into the battery, and after standing for 1 hour to allow the liquid to completely wet the electrodes, assembling a liquid button battery.

### Comparative Example 2

(1) Preparing basal electrolyte solution.

(2) Preparing a ternary cathode sheet as a positive electrode and a graphite anode sheet as a negative electrode for a battery in the comparative example.

(3) Assembling the positive electrode, the negative electrode, a PE porous separator, and an aluminum-plastic film into an unfilled dry cell by layer-by-layer lamination, which was dried at 90° C. for 24 hours and reserved for use.

The basal electrolyte solution prepared in the step (1) was injected into the dry cell prepared in the step (3). After standing for 12 hours, a liquid state pouch battery was prepared through formation and aging processes.

### Test Example 1

A capacity test was conducted on the semi-solid button batteries prepared in Example 2 to Example 7 and the liquid button battery prepared in Comparative Example 1. Test conditions for the button batteries were as follows:
1. testing equipment: LAND battery test system;
2. testing method: room temperature testing with a charging protocol consisted of constant-current charging and constant-voltage charging, as well as constant-current discharging; and
3. parameter settings: a first cycle was performed at 0.1C for both charging and discharging, followed by subsequent cycles at 0.33C, and a testing voltage range was from 2.5V to 3.75V.

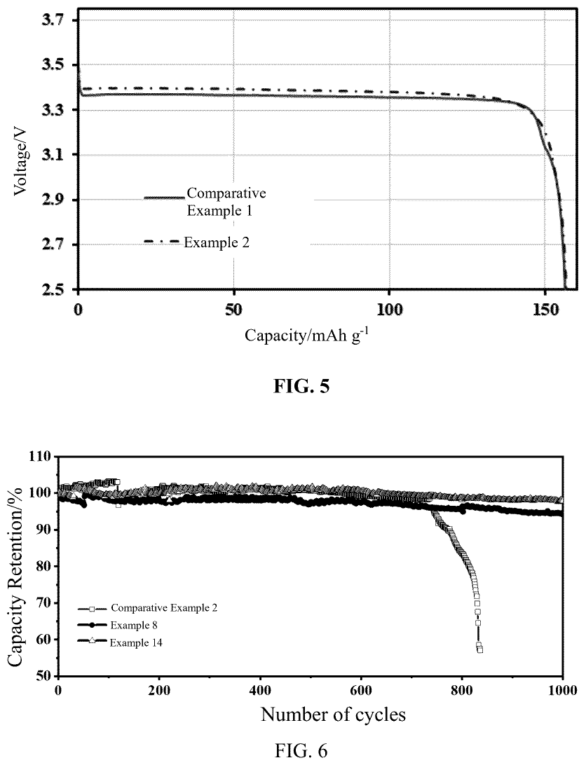

The test results are shown in FIG. 5 and Table 3.

TABLE 3

| | | First-cycle |
|---|---|---|
| Sample | Battery capacity(mAh/g) | efficiency |
| Example 2 | 156.3 | 96.4% |
| Example 3 | 153.1 | 94.6% |
| Example 4 | 151.5 | 93.2% |
| Example 5 | 154.6 | 95.6% |
| Example 6 | 155.3 | 95.2% |
| Example 7 | 156.7 | 96.3% |
| Comparative Example 1 | 156.2 | 96.1% |

### Test Example 2

A capacity test and a safety performance test were conducted on the semi-solid state stacked pouch batteries prepared in Example 8 to Example 13 and the liquid state pouch battery prepared in Comparative Example 2. The testing methods refer to GB/T 31486-2015.

TABLE 4

| | | Needle |
|---|---|---|
| Sample | Battery capacity (Ah) | penetration test |
| Example 8 | 54.7 | Pass |
| Example 9 | 52.6 | Pass |
| Example 10 | 51.2 | Pass |
| Example 11 | 54.7 | Pass |
| Example 12 | 53.1 | Pass |
| Example 13 | 55.6 | Pass |
| Example 14 | 54.4 | Pass |
| Comparative | 55.2 | Fail |
| Example 2 | | |

The results are shown in Table 4. It was found in the tests that the semi-solid batteries prepared in each example have slightly lower capacity compared to the liquid battery in Comparative Example 2, but they pass the needle penetration safety test, demonstrating higher safety performance than existing liquid state lithium-ion batteries.

### Test Example 3

A cycle lift test was conducted on the semi-solid state stacked pouch batteries prepared in Example 8 and Example 14 and the liquid state pouch battery prepared in Comparative Example 2. The testing method refers to GB/T 31486-2015.

TABLE 5

| Sample | Number of cycles |
|---|---|
| Example 8 | 1000 (Capacity Retention 97.8%) |
| Example 14 | 1000 (Capacity Retention 94.4%) |
| Comparative | Less than 800 |
| Example 2 | |

The test results are shown in FIG. 6 and Table 5. It can be seen from the results that the cells with in-situ polymerized semi-solid state electrolytes exhibit better structural stability and higher electrolyte retention efficiency, which enhances the cycle performance of the battery and significantly prolongs the cycle life.

Through the comparison between the examples and comparative examples, it can be seen that the cells with in-situ polymerized semi-solid state electrolytes have better structural stability and can pass the safety test. The battery prepared by the self-assembled hierarchical in-situ curing method has better targeting than the battery prepared by the traditional in-situ polymerization method, which can more specifically protect the positive and negative electrodes, resulting in higher safety performance of the prepared cells. Compared with conventional liquid batteries, the semi-solid state battery prepared in the present invention has slightly lower capacity, but the capacity loss was acceptable compared to the improvement in safety. The overall performance of the battery was significantly improved considering comprehensive factors. Moreover, the preparation method of the present invention is simple, highly compatible with a production line, and easy to scale up for mass production.

1. A method for preparing a semi-solid state battery, the semi-solid state battery comprising a cell and an electrolyte, the cell comprising stacked positive and negative electrodes, wherein the preparation method comprises the following steps:
(1) mixing a first reactive monomer, a second reactive monomer, and a portion of a basal electrolyte solution to obtain an in-situ polymerization electrolyte precursor I;
(2) mixing an initiator with a remainder of the basal electrolyte solution to obtain an in-situ polymerization electrolyte precursor II, the initiator being used to initiate polymerization of the first reactive monomer and polymerization of the second reactive monomer respectively; and
(3) first injecting the in-situ polymerization electrolyte precursor I into the cell to wet the positive and negative electrodes, then injecting the in-situ polymerization electrolyte precursor II into the cell, heating the cell to a polymerization temperature to initiate in-situ polymerization, and forming a semi-solid state battery having a multi-layer network electrolyte structure,
wherein the first reactive monomer has a faster polymerization rate and forms a polymer with a higher molecular weight than the second reactive monomer.

2. The method for preparing a semi-solid state battery according to claim 1, wherein the first reactive monomer completes at least 80% of the polymerization within 60 seconds of reaction after addition of the initiator; and the second reactive monomer completes less than 50% of the polymerization within 60 seconds of reaction after the addition of the initiator.

3. The method for preparing a semi-solid state battery according to claim 1, wherein the first reactive monomer is at least one of the followings: methyl methacrylate, 1,3-dioxolane, methyl acrylate, and polyethylene glycol dimethacrylate; and
the second reactive monomer is at least one of the followings: polyethylene glycol methacrylate, dimethyl allylmalonate, and vinylene carbonate.

4. The method for preparing a semi-solid state battery according to claim 1, wherein the initiator is at least one of the followings: azobisisobutyronitrile and benzoyl peroxide.

5. The method for preparing a semi-solid state battery according to claim 1, wherein a mass fraction of the first reactive monomer in the in-situ polymerization electrolyte precursor I is 5% to 45%;
a mass fraction of the second reactive monomer in the in-situ polymerization electrolyte precursor I is 0.5% to 45%; and
a mass fraction of the initiator in the in-situ polymerization electrolyte precursor II is 0.1% to 5%.

6. The method for preparing a semi-solid state battery according to claim 1, wherein in the step (3), the in-situ polymerization electrolyte precursor I and the in-situ polymerization electrolyte precursor II are added in a mass ratio of 1:1.

7. The method for preparing a semi-solid state battery according to claim 1, wherein in the step (3), during the in-situ polymerization, a heating temperature is 45° C. to 90° C. and a heating time is 5 minutes to 48 hours.

8. The method for preparing a semi-solid state battery according to claim 7, wherein in the step (3), after the heating during the in-situ polymerization, standing is performed at a standing temperature of 25° C. to 45° C. for a standing time of 24 hours to 120 hours.

9. A semi-solid state battery prepared by the preparation method according to claim 1.

10. The semi-solid state battery according to claim 9, wherein the semi-solid state battery is a semi-solid state button battery or a semi-solid state stacked pouch battery.
